(19) United States
(12) Patent Application Publication
(10) Pub. No.: US 2024/0193605 A1
(43) Pub. Date: Jun. 13, 2024

(54) PAYMENT INFORMATION PROCESSING METHOD, APPARATUS, AND DEVICE, AND MEDIUM

(71) Applicant: ALIPAY .COM CO., LTD., Hangzhou, Zhejiang (CN)

(72) Inventors: Hui Chen, Hangzhou (CN); Can Ma, Hangzhou (CN); Zhengming Shen, Hangzhou (CN); Wei Liao, Hangzhou (CN)

(21) Appl. No.: 18/555,177

(22) PCT Filed: Apr. 8, 2022
(86) PCT No.: PCT/CN2022/085694

§ 371 Date: Oct. 12, 2023

(30) Foreign Application Priority Data
Apr. 12, 2021 (CN) 202110389828.0

(51) Int. Cl. G06Q 20/40; G06Q 20/38

(52) U.S. Cl. CPC G06Q 20/4014; G06Q 20/38215; G06Q 20/4016; G06Q 2220/00

(57) ABSTRACT

Embodiments of this specification disclose a payment information processing method, apparatus, and device, and a medium. The solution can include: obtaining a payment request that is sent by a target organization and that is generated based on a payment operation performed by a user, where the payment request includes identification information of an authorized payment account; determining account status information of the authorized payment account; determining, based on the account status information, whether a transaction corresponding to the payment request is at a transaction risk, to obtain a first determining result; and if the first determining result indicates that the transaction is not at a transaction risk, performing a first payment procedure; or if the first determining result indicates that the transaction is at a transaction risk, performing a second payment procedure including a first identity verification process.

### TECHNICAL FIELD

This specification relates to the field of computer technologies, and in particular, to a payment information processing method, apparatus, and device, and a medium.

### BACKGROUND

With development of computer technologies, an increasingly large quantity of users purchase required products online. After the user selects a required commodity, when an online payment is made, a third-party payment service needs to be invoked, a payment channel needs to be selected, and information such as a payment password needs to be entered, to complete the online payment. In an entire process, the user needs to perform a specific operation. For example, when the user makes a plurality of online payments, the user needs to repeatedly enter information such as the payment password, and a user operation is cumbersome.

Therefore, how to enable the user to quickly and securely perform payment processing is an urgent technical problem to be resolved.

### SUMMARY

Embodiments of this specification provide a payment information processing method, apparatus, and device, and a medium, so that a user can quickly and securely perform payment processing.

The embodiments of this specification are implemented as follows: An embodiment of this specification provides a payment information processing method, including: obtaining a payment request that is sent by a target organization and that is generated based on a payment operation performed by a user, where the payment request includes identification information of an authorized payment account, and the authorized payment account is a payment account for which a one-step payment authorization relationship with the target organization is established in advance; determining account status information of the authorized payment account; determining, based on the account status information, whether a transaction corresponding to the payment request is at a transaction risk, to obtain a first determining result; and if the first determining result indicates that the transaction is not at a transaction risk, performing a first payment procedure; or if the first determining result indicates that the transaction is at a transaction risk, performing a second payment procedure including a first identity verification process.

An embodiment of this specification provides a payment information processing apparatus, including: a request obtaining module, configured to obtain a payment request that is sent by a target organization and that is generated based on a payment operation performed by a user, where the payment request includes identification information of an authorized payment account, and the authorized payment account is a payment account for which a one-step payment authorization relationship with the target organization is established in advance; an information determining module, configured to determine account status information of the authorized payment account; a first determining module, configured to determine, based on the account status information, whether a transaction corresponding to the payment request is at a transaction risk, to obtain a first determining result; and a first procedure module, configured to; if the first determining result indicates that the transaction is not at a transaction risk, perform a first payment procedure; or a second procedure module, configured to; if the first determining result indicates that the transaction is at a transaction risk, perform a second payment procedure including a first identity verification process.

An embodiment of this specification provides a payment information processing device, including at least one processor and a memory communicatively connected to the at least one processor. The memory stores instructions that can be executed by the at least one processor. The instructions are executed by the at least one processor, to enable the at least one processor to perform the following operations; obtaining a payment request that is sent by a target organization and that is generated based on a payment operation performed by a user, where the payment request includes identification information of an authorized payment account, and the authorized payment account is a payment account for which a one-step payment authorization relationship with the target organization is established in advance; determining account status information of the authorized payment account; determining, based on the account status information, whether a transaction corresponding to the payment request is at a transaction risk, to obtain a first determining result; and if the first determining result indicates that the transaction is not at a transaction risk, performing a first payment procedure; or if the first determining result indicates that the transaction is at a transaction risk, performing a second payment procedure including a first identity verification process.

An embodiment of this specification provides a computer-readable medium. The computer-readable medium stores computer-readable instructions, and the computer-readable instructions can be executed by a processor to implement the payment information processing method.

The embodiments of this specification can achieve the following beneficial effects: In the embodiments of this specification, a one-step payment authorization relationship can be established between the authorized payment account and the target organization, so that a one-step payment can be made by using the authorized payment account. It is determined whether the transaction corresponding to the payment request is at a transaction risk, to determine whether a one-step payment can be performed. If the transaction is not at a risk, a one-step payment can be made, to improve payment efficiency. If the transaction is at a risk, identity verification can be performed, a payment is made through identity verification, and no new payment request needs to be initiated. Therefore, a payment procedure can be simplified while payment security is ensured. In addition, a quantity of times that the target organization initiates the payment request can be reduced, a data processing amount of the target organization and a third-party payment service organization that performs payment information processing can be reduced, and payment information processing efficiency can be improved.

### BRIEF DESCRIPTION OF DRAWINGS

To describe technical solutions in the embodiments of this specification or in the existing technology more clearly, the following briefly describes the accompanying drawings required for describing the embodiments or the existing technology. Clearly, the accompanying drawings in the following description merely show some embodiments of this specification, and a person of ordinary skill in the art can still derive other drawings from these accompanying drawings without creative efforts.

FIG. 1 is a schematic architectural diagram illustrating an overall solution of a payment information processing method in an actual application scenario, according to an embodiment of this specification;

FIG. 2 is a schematic flowchart illustrating a payment information processing method, according to an embodiment of this specification;

FIG. 3 is a lane diagram illustrating generation of an authorization certificate, according to an embodiment of this specification;

FIG. 4 is a lane diagram illustrating a payment information processing method, according to an embodiment of this specification;

FIG. 5 is a schematic diagram illustrating a structure of a payment information processing apparatus, according to an embodiment of this specification; and

FIG. 6 is a schematic diagram illustrating a structure of a payment information processing device, according to an embodiment of this specification.

### DESCRIPTION OF EMBODIMENTS

To make the objectives, technical solutions, and advantages of one or more embodiments of this specification clearer, the following clearly and comprehensively describes the technical solutions of the one or more embodiments of this specification with reference to corresponding accompanying drawings and specific embodiments of this specification. Clearly, the described embodiments are merely some but not all of the embodiments of this specification. All other embodiments obtained by a person of ordinary skill in the art based on the embodiments of this specification without creative efforts shall fall within the protection scope of one or more embodiments of this specification.

The technical solutions provided in the embodiments of this specification are described in detail below with reference to the accompanying drawings.

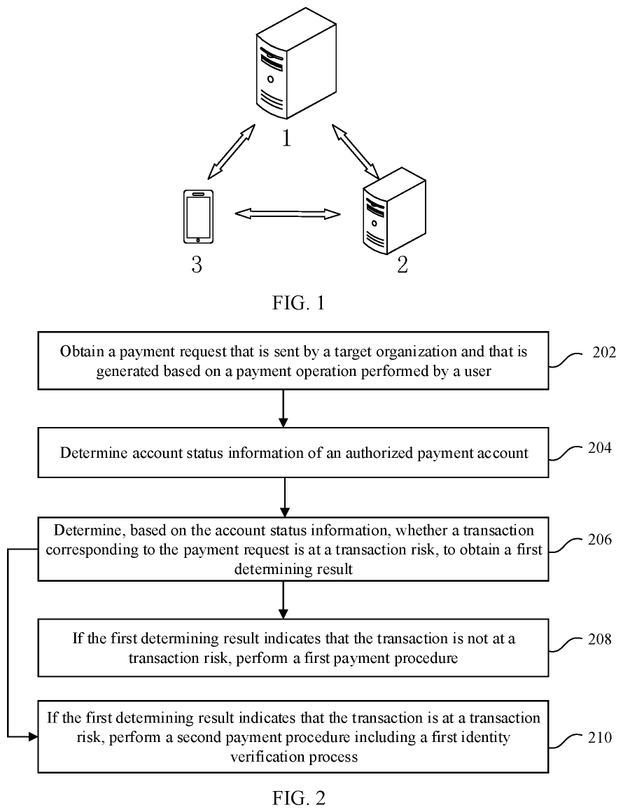

To resolve a disadvantage in the existing technology, the following embodiments are provided in the solution; FIG. 1 is a schematic architectural diagram illustrating an overall solution of a payment information processing method in an actual application scenario according to an embodiment of this specification. As shown in FIG. 1, the solution mainly includes a third-party payment service platform 1, a target organization 2 that can provide a service requirement service for a user, and a user terminal 3. The user can obtain, by using the terminal 3, a service from a service platform provided by the target organization 2. For example, the user can purchase a product on a shopping platform by using the terminal. The target organization 2 generates a payment request based on a payment operation performed by the user, and sends the payment request to the third-party payment service platform 1. The third-party payment service platform 1 determines whether a transaction corresponding to the payment request is at a transaction risk. If there is no transaction risk, a one-step payment can be made by using an authorized one-step payment account corresponding to the payment request. If there is a transaction risk, a payment procedure including identity verification can be performed. The user can make a payment by entering a password, the user does not need to perform a payment operation again, and the target organization does not need to submit a new payment request based on the payment operation performed by the user, to improve payment efficiency while ensuring payment security.

The payment information processing method provided in the embodiments of this specification is described below in detail with reference to the accompanying drawings. FIG. 2 is a schematic flowchart illustrating a payment information processing method, according to an embodiment of this specification. From a program perspective, the procedure can be performed by a program or an application client that is loaded on an application server. From a hardware perspective, the procedure can be performed by a third-party payment service platform that can perform payment information processing.

As shown in FIG. 2, the procedure can include the following steps: Step 202: Obtain a payment request that is sent by a target organization and that is generated based on a payment operation performed by a user, where the payment request includes identification information of an authorized payment account, and the authorized payment account is a payment account for which a one-step payment authorization relationship with the target organization is established in advance.

In this embodiment of this specification, the target organization can be an organization that provides a target service for the user. For example, the target organization can be an organization that provides a shopping platform for the user, and the user can purchase a product on the platform provided by the target organization. Alternatively, the target organization can be an organization that provides news information, literary works, and a service consulting service for the user, etc. The target organization can generate the payment request based on the payment operation performed by the user, and send the payment request to the payment service platform, so that the payment service platform processes the payment request sent by the target organization.

In this embodiment of this specification, the payment service platform can further establish a one-step payment authorization relationship between the target organization and a payment account based on authorization of the user. When processing a service based on the target organization, the user can make a one-step payment by using the authorized payment account, to simplify a payment operation performed by the user.
Step 204: Determine account status information of the authorized payment account.

In this embodiment of this specification, the payment request sent by the target organization can include the identification information of the authorized payment account, and the payment service platform can determine the account status information of the authorized payment account based on the payment request. The account status information can be information associated with the authorized payment account, and can include but is not limited to information such as information about a terminal on which the authorized payment account is logged in and balance information of the authorized payment account.
Step 206: Determine, based on the account status information, whether a transaction corresponding to the payment request is at a transaction risk, to obtain a first determining result.
Step 208: If the first determining result indicates that the transaction is not at a transaction risk, perform a first payment procedure.
Step 210: If the first determining result indicates that the transaction is at a transaction risk, perform a second payment procedure including a first identity verification process.

In this embodiment of this specification, it can be determined, based on the account status information of the authorized payment account, whether the transaction corresponding to the payment request is at a transaction risk. If there is no transaction risk, the first payment procedure can be performed to make a one-step payment, the user does not need to enter identity verification information such as a password, a fingerprint, or a face, and the current transaction can be completed. If there is a transaction risk, the second payment procedure including the first identity verification process can be performed to make an identity verification payment. After the user enters correct identity verification information such as a password, a fingerprint, or a face, the current transaction is completed. In this procedure, this transaction does not need to be ended, the user does not need to perform a payment operation again, and the target organization does not need to initiate a new payment request to the payment service platform. Therefore, a user operation can be simplified, interaction between the target organization and the payment service platform can be reduced, resources can be saved, and payment efficiency can be improved.

It should be understood that in the method described in one or more embodiments of this specification, sequences of some steps in the method can be exchanged with each other based on an actual requirement, or some steps in the method can be omitted or deleted.

In the method in FIG. 2, a one-step payment authorization relationship can be established between the authorized payment account and the target organization, so that a one-step payment can be made by using the authorized payment account. It is determined whether the transaction corresponding to the payment request is at a transaction risk, to determine whether a one-step payment can be performed. If the transaction is not at a risk, a one-step payment can be made, to improve payment efficiency. If the transaction is at a risk, identity verification can be performed, a payment is made through identity verification, and no new payment request needs to be initiated. Therefore, a payment procedure can be simplified while payment security is ensured. In addition, a quantity of times that the target organization initiates the payment request can be reduced, a data processing amount of the target organization and a third-party payment service organization that performs payment information processing can be reduced, and payment information processing efficiency can be improved.

Based on the method in FIG. 2, an embodiment of this specification further provides some specific implementations of the method, which are described below.

Optionally, in this embodiment of this specification, a payment procedure can be further determined based on a payment amount of the transaction. Specifically, the payment request in step 202 can include the payment amount, and before the determining, based on the account status information, whether a transaction corresponding to the payment request is at a transaction risk, the method can further include: determining, based on the payment request, whether the payment amount is less than or equal to a preset payment amount, to obtain a second determining result; and if the second determining result indicates that the payment amount is greater than the preset payment amount, performing a third payment procedure including a second identity verification process; and the determining whether a transaction corresponding to the payment request is at a transaction risk specifically includes: if the second determining result indicates that the payment amount is less than or equal to the preset payment amount, determining, based on the account status information, whether the transaction corresponding to the payment request is at a transaction risk.

In this embodiment of this specification, when a one-step payment authorization relationship is established between the authorized payment account and the target organization, the user, the target organization, or the payment service organization can further set an amount of a one-step payment. For example, the preset payment amount is 100 yuan. In this case, when the user makes a payment, if the payment amount is greater than 100 yuan, the user needs to provide identity verification information such as a payment password, a fingerprint, or a face to make an identity verification payment. If the payment amount is less than or equal to 100 yuan, it can be further determined whether there is a transaction risk to whether a one-step payment can be made. In this embodiment of this specification, a limit amount of the one-step payment can be set to improve payment security.

In this embodiment of this specification, a one-step payment authorization relationship between the authorized payment account and the target organization can be established. Specifically, the payment information processing method provided in this embodiment of this specification can further include: receiving a one-step payment authorization application sent by the target organization, where the one-step payment authorization application is generated based on an authorization application operation performed by the user in a terminal, and the one-step payment authorization application includes account information of a to-be-authorized payment account logged in on the terminal and organization identification information of the target organization; sending first payment verification indication information for the to-be-authorized payment account to the terminal; receiving first payment verification information that is sent by the terminal and that is in response to the first payment verification indication information; determining whether the first payment verification information is consistent with payment verification information preset for the to-be-authorized payment account, to obtain a third determining result, where the first payment verification information can include at least one of fingerprint information, face information, iris information, and password information; and if the third determining result indicates that the payment verification information is consistent with the payment verification information preset for the to-be-authorized payment account, generating an authorization certificate used for a one-step payment, where the authorization certificate used for a one-step payment indicates that a one-step payment authorization relationship is established between the to-be-authorized payment account and the target organization.

In an actual application, the user can log in to an application or a web page of the target organization in the terminal to perform service processing, and the user can perform an authorization application operation of a one-step payment in the application or the web page, to establish a one-step payment authorization relationship between a payment account and the target organization, so that the payment account is subsequently used to make a one-step payment. To ensure user account security, when establishing an authorization relationship, the user needs to provide payment verification information for the payment account, and the authorization relationship can be established only when verification succeeds.

In this embodiment of this specification, when an authorization relationship is established, the user can perform the authorization application operation based on an application client or the web page of the target organization. The one-step payment authorization application sent by the target organization can include an organization identifier of the target organization and the account information of the to-be-authorized payment account. The payment service platform can generate to-be-confirmed authorization certificate information based on the organization identifier and the account information of the payment account, and send the to-be-confirmed authorization certificate information to the terminal. Alternatively, the one-step payment authorization application does not include the account information of the to-be-authorized payment account. The payment service platform can determine a payment account currently logged in on the terminal as the to-be-authorized payment account, generate to-be-confirmed authorization certificate information based on the organization identifier and the payment account currently logged in on the terminal, and send the to-be-confirmed authorization certificate information to the terminal. After the user confirms the to-be-confirmed authorization certificate information, the payment service platform can generate a confirmed authorization certificate based on confirmation information of the user.

The payment service platform can store a correspondence among the target organization, the payment account, and the generated authorization certificate, to subsequently verify a one-step payment. Alternatively, the payment service platform can send the authorization certificate to the target organization. Subsequently, when the target organization sends the payment request, the authorization certificate can be carried, so that the payment service platform determines whether the authorization certificate sent by the target organization is valid, and whether an authorization relationship between the target organization and the payment account is established, to determine whether a one-step payment can be made.

In this embodiment of this specification, an account for establishing an authorization relationship with the target organization can be a payment account logged in on the user terminal when the user performs the authorization application operation. If a plurality of payment accounts are currently logged in on the user terminal, the user can select at least one payment account for establishing an authorization relationship with the target organization. In an implementation application, different payment accounts can correspond to different payment service platforms, and the payment service platform can further manage a payment account of another platform that has an association relationship with the platform.

In an actual application, the target organization can further determine, based on historical transaction information of the user, a payment account available to the user, and provide the payment account available to the user for the user, so that the user selects a payment account for establishing an authorization relationship with the target organization.

To improve payment security, the one-step payment in this embodiment of this specification can be a one-step payment based on a payment account currently logged in on the terminal. If the payment account currently logged in on the terminal is a payment account for which a one-step payment authorization relationship with the target organization is established, a one-step payment can be made based on the payment account. If the payment account currently logged in on the terminal is not a payment account for which a one-step payment authorization relationship with the target organization is established, a payment procedure including identity verification can be performed based on the payment account currently logged in on the terminal. Specifically, the payment request in this embodiment of this specification can include an organization identifier corresponding to the target organization and a device identifier of a terminal that receives the payment operation performed by the user; before the determining whether a transaction corresponding to the payment request is at a transaction risk, the method further includes; determining, based on the device identifier, a login payment account currently logged in on the terminal; determining, based on the authorization certificate, whether the login payment account is consistent with the authorized payment account corresponding to the authorization certificate, to obtain a fourth determining result; and if the fourth determining result indicates that the login payment account is inconsistent with the payment account corresponding to the authorization certificate, performing a fourth payment procedure including a third identity verification process; and the determining whether a transaction corresponding to the payment request is at a transaction risk may specifically include: if the fourth determining result indicates that the login payment account is consistent with the authorized payment account corresponding to the authorization certificate, determining, based on the account status information, whether the transaction corresponding to the payment request is at a transaction risk.

In another implementation, in this embodiment of this specification, it can be determined, based on a login payment account currently logged in on the terminal, whether an organization for which a one-step payment authorization relationship with the login payment account is established is the target organization that sends the payment request. If the organization for which a one-step payment authorization relationship with the login payment account is established is the target organization that sends the payment request, it can be further determined whether the transaction is at a transaction risk. If the organization for which a one-step payment authorization relationship with the login payment account is established is not the target organization that sends the payment request, a payment procedure including identity verification needs to be performed.

In an actual application, when performing service processing in the target organization, the user may need to log in, before performing service processing, to an account registered by the user with the target organization. In this embodiment of this specification, the organization identifier corresponding to the target organization can carry a user identifier of the user in the target organization, for example, the registered account and a registered name of the user in the target organization, used to distinguish between user identifiers of different users in the target organization. The payment service platform can determine, based on the authorization certificate, whether a user of the target organization that initiates the payment request is a user for which an authorization relationship with the authorized payment account is established. If the user of the target organization that initiates the payment request is the user for which an authorization relationship with the authorized payment account is established, it can be further determined whether the transaction is at a transaction risk. If the user of the target organization that initiates the payment request is not the user for which an authorization relationship with the authorized payment account is established, an identity verification procedure needs to be performed.

When the user does not need to register as a user of the target organization or log in to a registered account of the user in the target organization to perform service processing, the authorization certificate can be a one-step payment authorization relationship established between the organization identifier of the target organization and the authorized payment account.

In this embodiment of this specification, after it is determined that the payment account logged in on the terminal is an authorized payment account of the target organization, if the transaction is at a transaction risk, identity verification for the authorized payment account can be performed. Specifically, the first identity verification process in step 210 can be specifically an identity verification process for the authorized payment account corresponding to the authorization certificate.

Correspondingly, the third identity verification process can be specifically an identity verification process for the login payment account.

Considering that the authorization certificate may have time validity, that is, within a preset time period existing after the authorization certificate is generated, a one-step authorization payment can be made based on the authorization certificate, in this embodiment of this specification, before the determining whether a transaction corresponding to the payment request is at a transaction risk in step 206, the method can further include: determining, based on the payment request, an initiation time at which the payment request is initiated; determining whether the initiation time is within a validity period of the authorization certificate, to obtain a fifth determining result; and if the fifth determining result indicates that the initiation time is not within the validity period of the authorization certificate, performing a fifth payment procedure including fourth identity verification; and the determining whether a transaction corresponding to the payment request is at a transaction risk specifically includes: if the fifth determining result indicates that the initiation time is within the validity period of the authorization certificate, determining, based on the account status information, whether the transaction corresponding to the payment request is at a transaction risk.

The validity period of the authorization certificate can be set by the user, or can be determined by the payment service platform based on qualifications of the user and the target organization. For example, for a user and a target organization with relatively high credibility, a relatively long validity period can be set. In an implementation application, when the validity period of the authorization certificate expires or a preset time before the validity period expires, the target organization can send renewal prompt information to the user terminal, and the user can select to renew or terminate based on the prompt information.

To improve security of a one-step payment, in this embodiment of this specification, before the authorization certificate is generated, the payment service platform can perform authorization qualification verification on the to-be-authorized payment account and the target organization. For example, the target organization needs to submit registered information of the organization. Validity of the target organization is determined based on the registered information of the organization, and a registered capital of the organization can be further determined based on the registered information of the organization to determine whether the registered capital is greater than or equal to a preset capital standard. Only when the registered capital is greater than or equal to the preset capital standard, the target organization may be allowed to make a one-step payment. For another example, credibility of the target organization can be further determined based on a processing result of a previous historical service of the target organization. For another example, based on an account status of the user payment account, validity of the payment account can be determined, and it can be determined whether the payment account is an available account and an account whose credibility satisfies a requirement.

In this embodiment of this specification, the determining, based on the account status information, whether a transaction corresponding to the payment request is at a transaction risk in step 206 can specifically include: determining risk assessment basis information based on the account status information, where the risk assessment basis information can include at least one of a device identifier of a terminal that receives the payment operation performed by the user. GPS location information of the terminal, and IP address information of the terminal; and determining, based on the risk assessment basis information, whether the transaction corresponding to the payment request is at a transaction risk.

In an actual application, the payment request sent by the target organization can include at least one of the device identifier of the terminal in which the user performs the payment operation, the GPS location information of the terminal, and the IP address information of the terminal. In another implementation, the payment service platform can send a request for obtaining risk assessment basis information to the target organization based on the payment request, and the target organization can feed back corresponding information to the payment service platform based on the request. A method in which the payment service platform obtains the risk assessment basis information is not limited in this embodiment of this specification, provided that the payment service platform can determine, based on the risk assessment basis information, whether the transaction is at a transaction risk.

In an implementation, the determining, based on the risk assessment basis information, whether the transaction corresponding to the payment request is at a transaction risk in this embodiment of this specification can specifically include: determining a device identifier of a frequently used login device of the authorized payment account based on the account status information; determining whether the device identifier of the terminal that receives the payment operation performed by the user is consistent with the device identifier of the frequently used login device; and if the device identifier of the terminal that receives the payment operation performed by the user is consistent with the device identifier of the frequently used login device, determining that the transaction corresponding to the payment request is not at a transaction risk; or if the device identifier of the terminal that receives the payment operation performed by the user is inconsistent with the device identifier of the frequently used login device, determining that the transaction corresponding to the payment request is at a transaction risk; or determining a device identifier of a bound device of the authorized payment account based on the account status information, where the bound device is a device for which a binding relationship with the payment account is set in advance; determining whether the device identifier of the terminal that receives the payment operation performed by the user is consistent with the device identifier of the bound device; and if the device identifier of the terminal that receives the payment operation performed by the user is consistent with the device identifier of the bound device, determining that the transaction corresponding to the payment request is not at a transaction risk; or if the device identifier of the terminal that receives the payment operation performed by the user is inconsistent with the device identifier of the bound device, determining that the transaction corresponding to the payment request is at a transaction risk.

The frequently used login device can be a device that is in a set of devices on which the payment account is successfully logged in within a preset time period and that accounts for a percentage greater than or equal to a preset percentage, for example, a terminal device on which the payment account is successfully logged in for a largest quantity of times in last one month, or a terminal device corresponding to longest accumulated duration of a login time.

In an actual application, the user can set a bound device of the payment account in an application client corresponding to the payment service platform, or the payment service platform can set a first terminal device on which the payment account is logged in as a bound device, and the user can further change the bound device based on a requirement. Setting of the bound device is not specifically limited here.

In another implementation, the determining, based on the risk assessment basis information, whether the transaction corresponding to the payment request is at a transaction risk in this embodiment of this specification specifically includes; determining the IP address information of the terminal based on the account status information; determining IP address information of a previous successful transaction of the authorized payment account based on the identification information of the authorized payment account; determining whether the IP address information of the terminal is consistent with the IP address information of the previous successful transaction of the authorized payment account; and if the IP address information of the terminal is consistent with the IP address information of the previous successful transaction of the authorized payment account, determining that the transaction corresponding to the payment request is not at a transaction risk; or if the IP address information of the terminal is inconsistent with the IP address information of the previous successful transaction of the authorized payment account, determining that the transaction corresponding to the payment request is at a transaction risk; or determining the IP address information of the terminal based on the account status information; determining frequently used transaction IP address information of the authorized payment account based on the identification information of the authorized payment account; determining whether the IP address information of the terminal is consistent with the frequently used transaction IP address information of the authorized payment account; and if the IP address information of the terminal is consistent with the frequently used transaction IP address information of the authorized payment account, determining that the transaction corresponding to the payment request is not at a transaction risk; or if the IP address information of the terminal is inconsistent with the frequently used transaction IP address information of the authorized payment account, determining that the transaction corresponding to the payment request is at a transaction risk.

In an actual application, the user performs a payment operation in the terminal, and the target organization initiates a transaction request. The payment request can carry the IP address information of the terminal. The payment service platform can determine an IP address of the previous successful transaction of the authorized payment account and a frequently used IP address of the authorized payment account based on historical transaction information of the authorized payment account.

The frequently used IP address can be an IP address that is in a set of IP addresses at which a transaction is successfully made by using the payment account within a preset time period and that accounts for a percentage greater than or equal to a preset percentage, for example, an IP address at which a largest quantity of transactions are successfully made by using the payment account in last three months.

In an actual application, when the user uses the client of the target organization, the user can agree with the target organization to obtain geographical location information of the user terminal. For example, the user can agree with the target organization to obtain GPS positioning information of the user terminal. In this embodiment of this specification, it can be determined, based on the geographical location information of the user terminal, whether the transaction is at a transaction risk. Specifically, the determining, based on the risk assessment basis information, whether the transaction corresponding to the payment request is at a transaction risk can specifically include: determining the device identifier of the terminal based on the account status information; determining the geographical location information of the terminal based on the device identifier of the terminal; determining frequently used geographical location information of a successful transaction corresponding to the authorized payment account based on the identification information of the authorized payment account; determining whether the geographical location information of the terminal is consistent with the frequently used geographical location information of the successful transaction corresponding to the authorized payment account; and if the geographical location information of the terminal is consistent with the frequently used geographical location information of the successful transaction corresponding to the authorized payment account, determining that the transaction corresponding to the payment request is not at a transaction risk; or if the geographical location information of the terminal is inconsistent with the frequently used geographical location information of the successful transaction corresponding to the authorized payment account, determining that the transaction corresponding to the payment request is at a transaction risk.

The frequently used geographical location information can be geographical location information that is in a set of geographical location information based on which a transaction is successfully made by using the payment account within a preset time period and that accounts for a percentage greater than or equal to a preset percentage, for example, geographical location information based on which a largest quantity of transactions are successfully made by using the payment account in last two months.

In an actual application, the payment service platform can obtain the geographical location information of the transaction terminal from the target organization. When the user agrees with the payment service platform to obtain the geographical location information of the user terminal, the payment service platform can independently determine a geographical location of the user terminal. A specific method for obtaining the geographical location information is not specifically limited here.

In an implementation, whether the current transaction is at a transaction risk can be determined by determining whether geographical location information of the current transaction is consistent with geographical location information of a previous successful transaction of the authorized payment account. Specifically, in this embodiment of this specification, the determining, based on the risk assessment basis information, whether the transaction corresponding to the payment request is at a transaction risk can specifically include: determining the device identifier of the terminal based on the account status information; determining geographical location information of the terminal based on the device identifier of the terminal; determining the geographical location information of the terminal corresponding to the previous successful transaction of the authorized payment account based on the identification information of the authorized payment account; determining whether the geographical location information of the terminal is consistent with the geographical location information of the terminal corresponding to the previous successful transaction of the authorized payment account; and if the geographical location information of the terminal is consistent with the geographical location information of the terminal corresponding to the previous successful transaction of the authorized payment account, determining that the transaction corresponding to the payment request is not at a transaction risk; or if the geographical location information of the terminal is inconsistent with the geographical location information of the terminal corresponding to the previous successful transaction of the authorized payment account, determining that the transaction corresponding to the payment request is at a transaction risk.

In an actual application, there may be a plurality of available payment accounts for the user to make a transaction in the target organization, or one payment account of the user may be associated with a plurality of payment accounts, and the user can use one of the plurality of payment accounts to make a transaction payment.

In this embodiment of this specification, the authorized payment account can include at least one payment sub-account; and the performing a first payment procedure can specifically include: determining a first payment sequence preset for all payment sub-accounts; determining a first payment sub-account that is in all the payment sub-accounts and whose account balance is greater than or equal to a payment amount corresponding to the payment request as a first target payment account based on the first payment sequence; and deducting the payment amount from the first target payment account.

In this embodiment of this specification, when the authorized payment account includes a plurality of payment sub-accounts, an account by using which the current transaction amount can be paid can be selected to make a one-step payment. It can be understood that when any account by using which a one-step payment can be made exists in the authorized payment account, the one-step payment can be made, to increase a success rate of the one-step payment. In an actual application, after the transaction payment is completed, the payment service platform can further send transaction success information to the target organization and the client of the payment service platform corresponding to the user.

In this embodiment of this specification, when it is determined that the transaction is at a risk, even if the payment account currently logged in on the user terminal is an authorized payment account, and the authorization certificate between the target organization and the payment account is a valid certificate, a payment procedure including identity verification for the authorized payment account needs to be performed. Specifically, the performing a second payment procedure including a first identity verification process can specifically include: sending second payment verification indication information to the terminal, so that the user enters second payment verification information based on the second payment verification indication information, where the second payment verification information includes at least one of fingerprint information, face information, password information, and iris information; receiving the second payment verification information entered by the user; determining whether the second payment verification information is consistent with payment verification information preset for the authorized payment account corresponding to the authorization certificate; and if the second payment verification information is consistent with the payment verification information preset for the authorized payment account corresponding to the authorization certificate, deducting a payment amount corresponding to the payment request from the authorized payment account.

In this embodiment of this specification, the third payment procedure that includes the second identity verification process and that is performed after it is determined that the payment amount is greater than the preset payment amount can be a payment procedure including identity verification for the authorized payment account. The specific process can be the same as the process that is described above and in which the second payment procedure including the first identity verification process is performed. Identity verification is performed on the authorized payment account, and after the verification succeeds, a payment can be made by using the authorized payment account.

In this embodiment of this specification, the authorized payment account can include at least one authorized payment sub-account; before the sending second payment verification indication information to the terminal, the method can further include: determining a second payment sequence preset for all authorized payment sub-accounts; and determining a first authorized payment sub-account that is in all the authorized payment sub-accounts and whose account balance is greater than or equal to the payment amount corresponding to the payment request as a second target payment account based on the second payment sequence; the sending second payment verification indication information to the terminal can specifically include: sending second payment verification indication information for the second target payment account to the terminal; the determining whether the second payment verification information is consistent with payment verification information preset for the authorized payment account corresponding to the authorization certificate can specifically include: determining whether the second payment verification information is consistent with payment verification information preset for the second target payment account; and the deducting a payment amount corresponding to the payment request from the authorized payment account specifically includes: deducting the payment amount corresponding to the payment request from the second target payment account.

In an actual application, when there are a plurality of available authorized payment sub-accounts in the authorized payment account, the plurality of available authorized payment sub-accounts can be sorted based on the second payment sequence, and the plurality of sorted available authorized payment sub-accounts are sent to the user terminal. The terminal can present an account selection page that includes the plurality of sorted available authorized payment sub-accounts, and the user can select one of the accounts as the second target payment account.

In this embodiment of this specification, when the payment account currently logged in on the user terminal is not an authorized payment account, a payment can be made by using the payment account currently logged in, and a payment procedure does not need to be ended. Specifically, the performing a fourth payment procedure including a third identity verification process can specifically include: sending third payment verification indication information to the terminal, so that the user enters third payment verification information based on the third payment verification indication information, where the third payment verification information may include at least one of fingerprint information, face information, password information, and iris information; receiving the third payment verification information entered by the user; determining whether the third payment verification information is consistent with payment verification information preset for the login payment account; and if the third payment verification information is consistent with the payment verification information preset for the login payment account, deducting a payment amount corresponding to the payment request from the login payment account.

The login payment account can include at least one login payment sub-account; before the sending third payment verification indication information to the terminal, the method further includes; determining a third payment sequence preset for all login payment sub-accounts; and determining a first login payment sub-account that is in all the login payment sub-accounts and whose account balance is greater than or equal to the payment amount corresponding to the payment request as a third target payment account based on the third payment sequence; the sending third payment verification indication information to the terminal specifically includes: sending third payment verification indication information for the third target payment account to the terminal; the determining whether the third payment verification information is consistent with payment verification information preset for the login payment account specifically includes; determining whether the third payment verification information is consistent with payment verification information preset for the third target payment account; and the deducting a payment amount corresponding to the payment request from the login payment account specifically includes: deducting the payment amount corresponding to the payment request from the third target payment account.

In an actual application, all of the first payment sequence, the second payment sequence, and the third payment sequence can be set by the user in the client of the payment service platform, or the payment service platform can recommend a payment sequence to the user based on a habit of the user, and the user can further change or set the payment sequence based on a requirement. Setting of the payment sequence is not specifically limited here.

In an actual application, a quantity of one-step payments can be further set. For example, a quantity of one-step payments that can be made within a preset time period can be set. For example, it is set that eight one-step payments can be made within one month. When a ninth payment is made, the user needs to enter identity verification information to perform payment verification.

In this embodiment of this specification, identity verification information for a same account in different payment procedures can be the same. For example, when both the first identity verification process and the second identity verification process are for a same authorized payment account, payment verification information entered by the user can be the same, or can be set to be different. For example, in the first identity verification process, the user can enter fingerprint information for verification, and in the second identity verification process, the user can enter face information for verification. Similarly, for payment procedures of different payment accounts, the user can set different identity verification information, or can set same identity verification information. This can be set based on a user requirement. This is not specifically limited here.

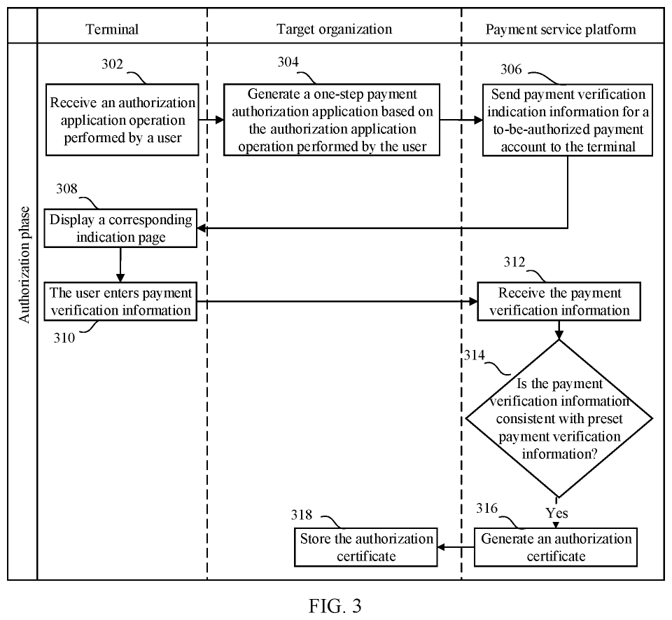

To describe the payment information processing method provided in the embodiments of this specification more clearly. FIG. 3 is a lane diagram illustrating generation of an authorization certificate, according to an embodiment of this specification. As shown in FIG. 3, an authorization phase of generating an authorization certificate can specifically include: Step 302: A terminal receives an authorization application operation performed by a user.
Step 304: A target organization generates a one-step payment authorization application based on the authorization application operation performed by the user, and sends the one-step payment authorization application to a payment service platform, where the one-step payment authorization application includes account information of a to-be-authorized payment account logged in on the terminal and organization identification information of the target organization. The target organization can further generate a to-be-confirmed authorization statement based on a one-step payment authorization statement template, and send the to-be-confirmed authorization statement to the user terminal, so that the user learns of specific content of a one-step payment and confirms the authorization statement. The target organization can further send the authorization statement confirmed by the user to the payment service platform.

In another implementation, the payment service platform can generate a to-be-confirmed authorization statement based on the one-step payment authorization application, and send the to-be-confirmed authorization statement to the target organization. The target organization sends the to-be-confirmed authorization statement to the user terminal, so that the user performs confirmation. In an actual application, the payment service platform can generate a to-be-confirmed authorization statement based on the one-step payment authorization application, and send the to-be-confirmed authorization statement to the user terminal. After the user performs confirmation, the confirmed authorization statement is sent to the target organization. A specific process is not limited here, provided that the payment service platform can receive information indicating confirmation by the user.
Step 306: The payment service platform sends first payment verification indication information for the to-be-authorized payment account to the terminal. The terminal can display an interface on which the user needs to provide first payment verification information. The user needs to provide the first payment verification information based on an indication.
Step 308: The terminal displays a corresponding indication page based on the first payment verification indication information.
Step 310: The user enters the first payment verification information in the terminal, to send the first payment verification information to the payment service platform.
Step 312: Receive the first payment verification information that is sent by the terminal and that is in response to the first payment verification indication information.
Step 314: Determine whether the first payment verification information is consistent with payment verification information preset for the to-be-authorized payment account currently logged in on the terminal, to obtain a third determining result.
Step 316: If the third determining result indicates that the first payment verification information is consistent with the payment verification information preset for the to-be-authorized payment account, generate an authorization certificate used for a one-step payment, where the authorization certificate used for a one-step payment indicates that a one-step payment authorization relationship is established between the to-be-authorized payment account and the target organization. The payment service platform can further send the generated authorization certificate to the target organization.
Step 318: The target organization stores the authorization certificate or an identifier of the authorization certificate sent by the payment service platform, so that the target organization subsequently initiates a payment request by carrying the authorization certificate or the identifier of the authorization certificate.

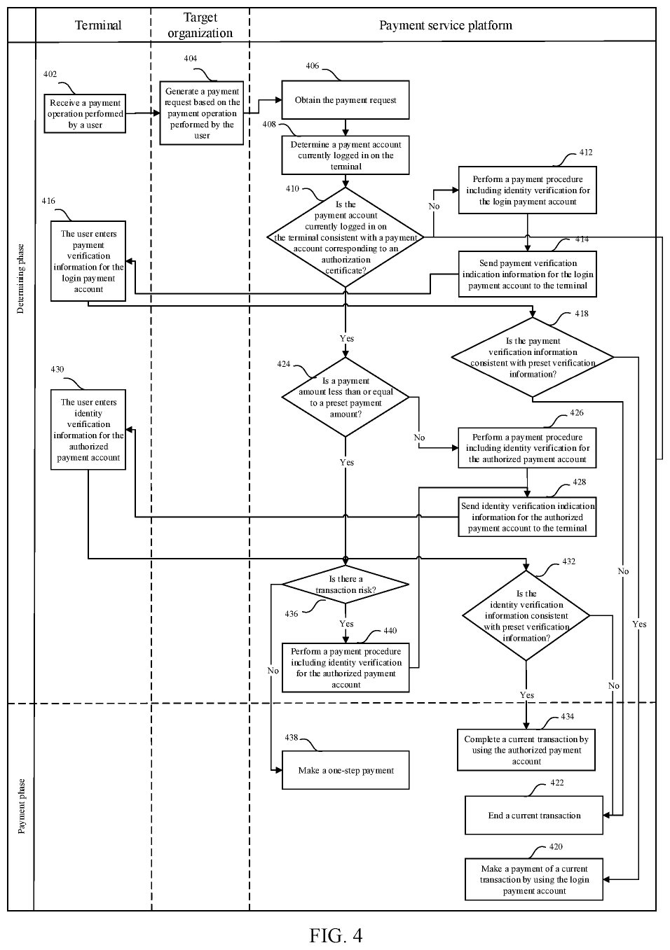

FIG. 4 is a lane diagram illustrating a payment information processing method, according to an embodiment of this specification. As shown in FIG. 4, the method mainly includes a determining phase and a payment phase, and can specifically include: step 402: A terminal receives a payment operation performed by a user. In an actual application, the payment operation performed by the user can be a confirmation operation performed by the user for a to-be-paid bill. For example, a target organization can generate the to-be-paid bill based on a commodity selected by the user, and the user can send, by tapping “submit order” or “confirm to pay”, an instruction indicating the payment operation to the target organization.
Step 404: The target organization generates a payment request based on the payment operation performed by the user, where the payment request includes identification information of an authorized payment account.
Step 406: A payment service platform obtains the payment request sent by the target organization, where the payment request includes an organization identifier corresponding to the target organization and a device identifier of the terminal that receives the payment operation performed by the user.
Step 408: Determine, based on the device identifier, a login payment account currently logged in on the terminal.
Step 410: Determine, based on an authorization certificate, whether the login payment account is consistent with the authorized payment account corresponding to the authorization certificate.
Step 412: If the login payment account is inconsistent with the authorized payment account corresponding to the authorization certificate, make a payment of a current transaction by using the login payment account, and perform a fourth payment procedure including a third identity verification process for the payment account currently logged in. This can specifically include: step 414: Send third payment verification indication information for the login payment account to the terminal. Step 416: The user enters third payment verification information for the login payment account in the terminal. Step 418: The payment service platform receives the third payment verification information entered by the terminal, and verifies the third payment verification information. Step 420: If the third payment verification information entered by the user for the login payment account is consistent with verification information preset for the login payment account, determine that the verification succeeds, and make a payment of the current transaction by using the login payment account. Step 422: If the third payment verification information entered by the user for the login payment account is inconsistent with verification information preset for the login payment account or a quantity of times that the third payment verification information entered by the user for the login payment account is inconsistent with verification information preset for the login payment account exceeds a preset quantity of times, determine that the verification fails, and end the current transaction.
Step 424: If the login payment account is consistent with the authorized payment account corresponding to the authorization certificate, determine, based on the payment request, whether a payment amount corresponding to the payment request is less than or equal to a preset payment amount.
Step 426: If the payment amount is greater than the preset payment amount, perform a third payment procedure including a second identity verification process for the authorized payment account. This can specifically include: Step 428: Send second payment verification indication information for the authorized payment account to the terminal. Step 430: The user enters second payment verification information for the authorized payment account in the terminal, and the terminal sends the information to the payment service organization. Step 432: The payment service organization receives the second payment verification information entered by the user, verifies the second payment verification information entered by the user for the authorized payment account, and determines whether the second payment verification information entered by the user for the authorized payment account is consistent with identity verification information preset for the authorized payment account. Step 434: If the second payment verification information entered by the user for the authorized payment account is consistent with the identity verification information preset for the authorized payment account, determine that the verification succeeds, and complete the current transaction by using the authorized payment account. If a quantity of times that the identity verification information entered by the user for the authorized payment account is inconsistent with the identity verification information preset for the authorized payment account exceeds a preset quantity of times, it indicates that the verification fails, and this transaction can be ended, as shown in step 422.
Step 436: If the payment amount is less than or equal to the preset payment amount, determine, based on account status information, whether a transaction corresponding to the payment request is at a transaction risk. Risk determining can be performed based on the device identifier of the terminal. GPS location information of the terminal. IP address information of the terminal, and the like.
Step 438: If the transaction corresponding to the payment request is not at a transaction risk, make a one-step payment based on the authorized payment account to complete the current transaction.
Step 440: If the transaction corresponding to the payment request is at a transaction risk, perform a payment procedure including an identity verification process for the authorized payment account. A specific process can be the same as step 428 to step 434. Details are not described here.

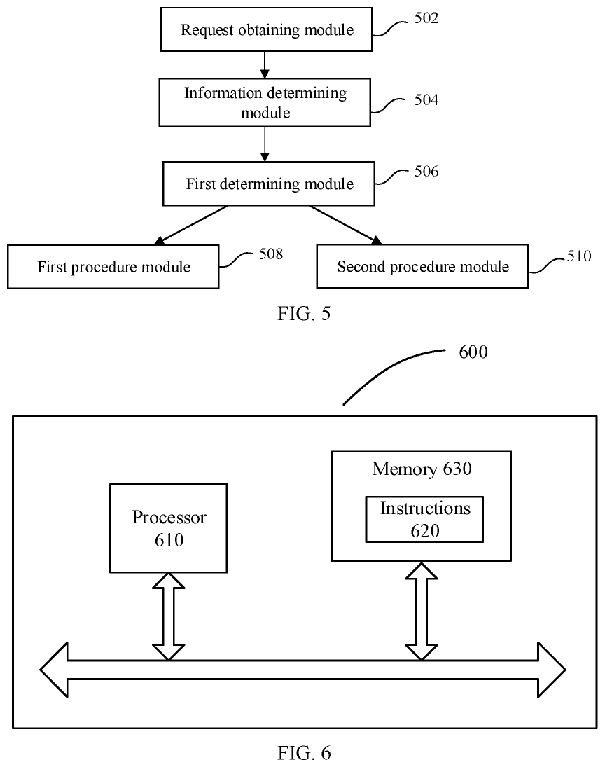

Based on the same idea, an embodiment of this specification further provides an apparatus corresponding to the previous method. FIG. 5 is a schematic diagram illustrating a structure of a payment information processing apparatus, according to an embodiment of this specification. As shown in FIG. 5, the apparatus can include: a request obtaining module 502, configured to obtain a payment request that is sent by a target organization and that is generated based on a payment operation performed by a user, where the payment request includes identification information of an authorized payment account, and the authorized payment account is a payment account for which a one-step payment authorization relationship with the target organization is established in advance; an information determining module 504, configured to determine account status information of the authorized payment account; a first determining module 506, configured to determine, based on the account status information, whether a transaction corresponding to the payment request is at a transaction risk, to obtain a first determining result; and a first procedure module 508, configured to: if the first determining result indicates that the transaction is not at a transaction risk, perform a first payment procedure; or a second procedure module 510, configured to: if the first determining result indicates that the transaction is at a transaction risk, perform a second payment procedure including a first identity verification process.

Based on the apparatus in FIG. 5, an embodiment of this specification further provides some specific implementations of the method, which are described below.

Optionally, the payment request in this embodiment of this specification can further include a payment amount, and the apparatus can further include: a second determining module, configured to determine, based on the payment request, whether the payment amount is less than or equal to a preset payment amount, to obtain a second determining result; and a third procedure module, configured to: if the second determining result indicates that the payment amount is greater than the preset payment amount, perform a third payment procedure including a second identity verification process; and the first determining module is specifically configured to: if the second determining result indicates that the payment amount is less than or equal to the preset payment amount, determine, based on the account status information, whether the transaction corresponding to the payment request is at a transaction risk.

Optionally, in this embodiment of this specification, the first determining module can be specifically configured to: determine risk assessment basis information based on the account status information, where the risk assessment basis information includes at least one of a device identifier of a terminal that receives the payment operation performed by the user. GPS location information of the terminal, and IP address information of the terminal; and determine, based on the risk assessment basis information, whether the transaction corresponding to the payment request is at a transaction risk.

Based on the same idea, an embodiment of this specification further provides a device corresponding to the previous method.

FIG. 6 is a schematic diagram illustrating a structure of a payment information processing device, according to an embodiment of this specification. As shown in FIG. 6, the device 600 can include at least one processor 610 and a memory 630 communicatively connected to the at least one processor. The memory 630 stores instructions 620 that can be executed by the at least one processor 610. The instructions are executed by the at least one processor 610, to enable the at least one processor 610 to perform the following operations; obtaining a payment request that is sent by a target organization and that is generated based on a payment operation performed by a user, where the payment request includes identification information of an authorized payment account, and the authorized payment account is a payment account for which a one-step payment authorization relationship with the target organization is established in advance; determining account status information of the authorized payment account; determining, based on the account status information, whether a transaction corresponding to the payment request is at a transaction risk, to obtain a first determining result; and if the first determining result indicates that the transaction is not at a transaction risk, performing a first payment procedure; or if the first determining result indicates that the transaction is at a transaction risk, performing a second payment procedure including a first identity verification process.

Based on the same idea, an embodiment of this specification further provides a computer-readable medium corresponding to the previous method. The computer-readable medium stores computer-readable instructions, and the computer-readable instructions can be executed by a processor to implement the information processing method described above.

The embodiments of this specification are described in a progressive way. For same or similar parts of the embodiments, mutual references can be made to the embodiments. Each embodiment focuses on a difference from other embodiments. Particularly, the device shown in FIG. 6 is basically similar to the method embodiment, and therefore is briefly described. For related parts, references can be made to related descriptions in the method embodiments.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, such programming is mostly implemented by using “logic compiler” software. The “logic compiler” software is similar to a software compiler used to develop and write a program. Original code needs to be written in a particular programming language before being compiled. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). At present, the Very-High-Speed Integrated Circuit Hardware Description Language (VHDL) and Verilog are most commonly used. A person skilled in the art should also understand that a hardware circuit that implements a logical method procedure can be readily obtained once the method procedure is logically programmed by using some described hardware description languages and is programmed into an integrated circuit.

A controller can be implemented by using any appropriate method. For example, the controller can be a microprocessor or a processor, or a computer-readable medium that stores computer readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D. Atmel AT91SAM. Microchip PIC18F26K20, and Silicone Labs C8051F320. The memory controller can also be implemented as a part of the control logic of the memory. A person skilled in the art also knows that, in addition to implementing the controller by using only the computer-readable program code, logic programming can be performed on method steps to enable the controller to implement the same function in forms of the logic gate, the switch, the application-specific integrated circuit, the programmable logic controller, the built-in microcontroller, etc. Therefore, the controller can be considered as a hardware component, and an apparatus configured to implement various functions in the controller can also be considered as a structure in the hardware component. Alternatively, the apparatus configured to implement various functions can even be considered as both a software module implementing the method and a structure in the hardware component.

The system, apparatus, module, or unit illustrated in the previous embodiments can be implemented by using a computer chip or an entity, or can be implemented by using a product having a certain function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, or a wearable device, or a combination of any of these devices.

For ease of description, the previous apparatus is divided to various units based on functions for separate description when the previous apparatus is described. Certainly, when this specification is implemented, a function of each unit can be implemented in one or more pieces of software and/or hardware.

A person skilled in the art should understand that an embodiment of this specification can be provided as a method, a system, or a computer program product. Therefore, this specification can use a form of hardware only embodiments, software only embodiments, or embodiments with a combination of software and hardware. Moreover, this specification can use a form of a computer program product that is implemented on one or more computer-usable storage media (including but not limited to a disk memory, a CD-ROM, an optical memory, etc.) that include computer-usable program code.

This specification is described with reference to the flowcharts and/or block diagrams of the method, the device (system), and the computer program product based on the embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more procedures in the flowcharts and/or in one or more blocks in the block diagrams.

Alternatively, these computer program instructions can be stored in a computer-readable memory that can instruct a computer or another programmable data processing device to work in a specific way, so the instructions stored in the computer-readable memory generate an artifact that includes an instruction apparatus. The instruction apparatus implements a specific function in one or more procedures in the flowcharts and/or in one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), one or more input/output interfaces, one or more network interfaces, and one or more memories.

The memory can include a non-persistent memory, a random access memory (RAM), a non-volatile memory, and/or another form in a computer-readable medium, for example, a read-only memory (ROM) or a flash memory (flash RAM). The memory is an example of the computer-readable medium.

The computer-readable medium includes persistent, non-persistent, removable and non-removable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of RAM, a ROM, an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be configured to store information that can be accessed by a computing device. As described in this specification, the computer-readable medium does not include computer-readable transitory media such as a modulated data signal and a carrier.

It should be further noted that the terms “include”. “comprise”, or any other variant thereof are intended to cover a non-exclusive inclusion such that a process, a method, a product or a device that includes a list of elements not only includes those elements but also includes other elements which are not expressly listed, or further includes elements inherent to such process, method, product or device. Without more constraints, an element preceded by “includes a . . . ” does not preclude the existence of additional identical elements in the process, method, product or device that includes the element.

A person skilled in the art should understand that an embodiment of this specification can be provided as a method, a system, or a computer program product. Therefore, this specification can use a form of hardware only embodiments, software only embodiments, or embodiments with a combination of software and hardware. Moreover, this specification can use a form of a computer program product that is implemented on one or more computer-usable storage media (including but not limited to a disk memory, a CD-ROM, an optical memory, etc.) that include computer-usable program code.

This specification can be described in the general context of computer-executable instructions, for example, a program module. Generally, the program module includes a routine, a program, an object, a component, a data structure, etc. executing a specific task or implementing a specific abstract data type. This specification can alternatively be practiced in distributed computing environments in which tasks are performed by remote processing devices that are connected through a communication network. In the distributed computing environments, the program module can be located in a local and remote computer storage medium including a storage device.

The previous descriptions are merely embodiments of this specification, and are not intended to limit this specification. A person skilled in the art can make various modifications and changes to this specification. Any modification, equivalent replacement, or improvement made without departing from the spirit and principle of this specification shall fall within the scope of the claims in this specification.

1. A payment information processing method, comprising:
obtaining a payment request that is sent by a target organization and that is generated based on a payment operation performed by a user, wherein the payment request comprises identification information of an authorized payment account, and the authorized payment account is a payment account for which a one-step payment authorization relationship with the target organization is established in advance;
determining account status information of the authorized payment account;
determining, based on the account status information, whether a transaction corresponding to the payment request is at a transaction risk, to obtain a first determining result; and
upon determining that the first determining result indicates that the transaction is not at a transaction risk, performing a first payment procedure; or
upon determining that the first determining result indicates that the transaction is at a transaction risk, performing a second payment procedure comprising a first identity verification process.

2. The method according to claim 1, wherein the payment request comprises a payment amount, and before the determining, based on the account status information, whether a transaction corresponding to the payment request is at a transaction risk, the method further comprises:
determining, based on the payment request, whether the payment amount is less than or equal to a preset payment amount, to obtain a second determining result; and
upon determining that the second determining result indicates that the payment amount is greater than the preset payment amount, performing a third payment procedure comprising a second identity verification process; and
the determining whether a transaction corresponding to the payment request is at a transaction risk specifically comprises:
upon determining that the second determining result indicates that the payment amount is less than or equal to the preset payment amount, determining, based on the account status information, whether the transaction corresponding to the payment request is at a transaction risk.

3. The method according to claim 1, wherein the method further comprises:
receiving a one-step payment authorization application sent by the target organization, wherein the one-step payment authorization application is generated based on an authorization application operation performed by the user in a terminal, and the one-step payment authorization application comprises account information of a to-be-authorized payment account logged in on the terminal and organization identification information of the target organization;
sending first payment verification indication information for the to-be-authorized payment account to the terminal;
receiving first payment verification information that is sent by the terminal and that is in response to the first payment verification indication information;
determining whether the first payment verification information is consistent with payment verification information preset for the to-be-authorized payment account, to obtain a third determining result; and
upon determining that the third determining result indicates that the first payment verification information is consistent with the payment verification information preset for the to-be-authorized payment account, generating an authorization certificate used for a one-step payment, wherein the authorization certificate used for a one-step payment indicates that a one-step payment authorization relationship is established between the to-be-authorized payment account and the target organization.

4. The method according to claim 3, wherein the payment request comprises an organization identifier corresponding to the target organization and a device identifier of a terminal that receives the payment operation performed by the user;
before the determining whether a transaction corresponding to the payment request is at a transaction risk, the method further comprises:
determining, based on the device identifier, a login payment account currently logged in on the terminal;
determining, based on the authorization certificate, whether the login payment account is consistent with the authorized payment account corresponding to the authorization certificate, to obtain a fourth determining result; and
upon determining that the fourth determining result indicates that the login payment account is inconsistent with the payment account corresponding to the authorization certificate, performing a fourth payment procedure comprising a third identity verification process; and
the determining whether a transaction corresponding to the payment request is at a transaction risk specifically comprises:
upon determining that the fourth determining result indicates that the login payment account is consistent with the authorized payment account corresponding to the authorization certificate, determining, based on the account status information, whether the transaction corresponding to the payment request is at a transaction risk.

5. The method according to claim 4, wherein the first identity verification process is specifically an identity verification process for the authorized payment account corresponding to the authorization certificate.

6. The method according to claim 3, wherein before the determining whether a transaction corresponding to the payment request is at a transaction risk, the method further comprises:
determining, based on the payment request, an initiation time at which the payment request is initiated;
determining whether the initiation time is within a validity period of the authorization certificate, to obtain a fifth determining result; and
upon determining that the fifth determining result indicates that the initiation time is not within the validity period of the authorization certificate, performing a fifth payment procedure comprising fourth identity verification; and
the determining whether a transaction corresponding to the payment request is at a transaction risk specifically comprises:
upon determining that the fifth determining result indicates that the initiation time is within the validity period of the authorization certificate, determining, based on the account status information, whether the transaction corresponding to the payment request is at a transaction risk.

7. The method according to claim 1, wherein the determining, based on the account status information, whether a transaction corresponding to the payment request is at a transaction risk specifically comprises:
determining risk assessment basis information based on the account status information, wherein the risk assessment basis information comprises at least one of a device identifier of a terminal that receives the payment operation performed by the user, GPS location information of the terminal, and IP address information of the terminal; and
determining, based on the risk assessment basis information, whether the transaction corresponding to the payment request is at a transaction risk.

8. The method according to claim 7, wherein the determining,
based on the risk assessment basis information, whether the transaction corresponding to the payment request is at a transaction risk specifically comprises:
determining a device identifier of a frequently used login device of the authorized payment account based on the account status information;
determining whether the device identifier of the terminal that receives the payment operation performed by the user is consistent with the device identifier of the frequently used login device; and
upon determining that the device identifier of the terminal that receives the payment operation performed by the user is consistent with the device identifier of the frequently used login device, determining that the transaction corresponding to the payment request is not at a transaction risk; or
upon determining that the device identifier of the terminal that receives the payment operation performed by the user is inconsistent with the device identifier of the frequently used login device, determining that the transaction corresponding to the payment request is at a transaction risk; or
determining a device identifier of a bound device of the authorized payment account based on the account status information, wherein the bound device is a device for which a binding relationship with the payment account is set in advance;
determining whether the device identifier of the terminal that receives the payment operation performed by the user is consistent with the device identifier of the bound device; and
upon determining that the device identifier of the terminal that receives the payment operation performed by the user is consistent with the device identifier of the bound device, determining that the transaction corresponding to the payment request is not at a transaction risk; or
upon determining that the device identifier of the terminal that receives the payment operation performed by the user is inconsistent with the device identifier of the bound device, determining that the transaction corresponding to the payment request is at a transaction risk.

9. The method according to claim 7, wherein the determining, based on the risk assessment basis information, whether the transaction corresponding to the payment request is at a transaction risk specifically comprises:
determining the IP address information of the terminal based on the account status information;
determining IP address information of a previous successful transaction of the authorized payment account based on the identification information of the authorized payment account;
determining whether the IP address information of the terminal is consistent with the IP address information of the previous successful transaction of the authorized payment account; and
upon determining that the IP address information of the terminal is consistent with the IP address information of the previous successful transaction of the authorized payment account, determining that the transaction corresponding to the payment request is not at a transaction risk; or
upon determining that the IP address information of the terminal is inconsistent with the IP address information of the previous successful transaction of the authorized payment account, determining that the transaction corresponding to the payment request is at a transaction risk; or
determining the IP address information of the terminal based on the account status information;
determining frequently used transaction IP address information of the authorized payment account based on the identification information of the authorized payment account;
determining whether the IP address information of the terminal is consistent with the frequently used transaction IP address information of the authorized payment account; and
upon determining that the IP address information of the terminal is consistent with the frequently used transaction IP address information of the authorized payment account, determining that the transaction corresponding to the payment request is not at a transaction risk; or
upon determining that the IP address information of the terminal is inconsistent with the frequently used transaction IP address information of the authorized payment account, determining that the transaction corresponding to the payment request is at a transaction risk.

10. The method according to claim 7, wherein the determining, based on the risk assessment basis information, whether the transaction corresponding to the payment request is at a transaction risk specifically comprises:
determining the device identifier of the terminal based on the account status information;
determining geographical location information of the terminal based on the device identifier of the terminal;
determining frequently used geographical location information of a successful transaction corresponding to the authorized payment account based on the identification information of the authorized payment account;
determining whether the geographical location information of the terminal is consistent with the frequently used geographical location information of the successful transaction corresponding to the authorized payment account; and
upon determining that the geographical location information of the terminal is consistent with the frequently used geographical location information of the successful transaction corresponding to the authorized payment account, determining that the transaction corresponding to the payment request is not at a transaction risk; or
upon determining that the geographical location information of the terminal is inconsistent with the frequently used geographical location information of the successful transaction corresponding to the authorized payment account, determining that the transaction corresponding to the payment request is at a transaction risk.

11. The method according to claim 1, wherein the authorized payment account comprises at least one payment sub-account; and
the performing a first payment procedure specifically comprises:
determining a first payment sequence preset for all payment sub-accounts;
determining a first payment sub-account that is in all the payment sub-accounts and whose account balance is greater than or equal to a payment amount corresponding to the payment request as a first target payment account based on the first payment sequence; and
deducting the payment amount from the first target payment account.

12. The method according to claim 5, wherein the performing a second payment procedure comprising a first identity verification process specifically comprises:
sending second payment verification indication information to the terminal, so that the user enters second payment verification information based on the second payment verification indication information;
receiving the second payment verification information entered by the user;
determining whether the second payment verification information is consistent with payment verification information preset for the authorized payment account corresponding to the authorization certificate; and
upon determining that the second payment verification information is consistent with the payment verification information preset for the authorized payment account corresponding to the authorization certificate, deducting a payment amount corresponding to the payment request from the authorized payment account.

13. The method according to claim 12, wherein the authorized payment account comprises at least one authorized payment sub-account;
before the sending second payment verification indication information to the terminal, the method further comprises:
determining a second payment sequence preset for all authorized payment sub-accounts; and
determining a first authorized payment sub-account that is in all the authorized payment sub-accounts and whose account balance is greater than or equal to the payment amount corresponding to the payment request as a second target payment account based on the second payment sequence;
the sending second payment verification indication information to the terminal specifically comprises:
sending second payment verification indication information for the second target payment account to the terminal;
the determining whether the second payment verification information is consistent with payment verification information preset for the authorized payment account corresponding to the authorization certificate specifically comprises:
determining whether the second payment verification information is consistent with payment verification information preset for the second target payment account; and
the deducting a payment amount corresponding to the payment request from the authorized payment account specifically comprises:
deducting the payment amount corresponding to the payment request from the second target payment account.

14. The method according to claim 4, wherein the performing a fourth payment procedure comprising a third identity verification process specifically comprises:
sending third payment verification indication information to the terminal, so that the user enters third payment verification information based on the third payment verification indication information;
receiving the third payment verification information entered by the user;
determining whether the third payment verification information is consistent with payment verification information preset for the login payment account; and
upon determining that the third payment verification information is consistent with the payment verification information preset for the login payment account, deducting a payment amount corresponding to the payment request from the login payment account.

15. The method according to claim 14, wherein the login payment account comprises at least one login payment sub-account;
before the sending third payment verification indication information to the terminal, the method further comprises:
determining a third payment sequence preset for all login payment sub-accounts; and
determining a first login payment sub-account that is in all the login payment sub-accounts and whose account balance is greater than or equal to the payment amount corresponding to the payment request as a third target payment account based on the third payment sequence;
the sending third payment verification indication information to the terminal specifically comprises:
sending third payment verification indication information for the third target payment account to the terminal;
the determining whether the third payment verification information is consistent with payment verification information preset for the login payment account specifically comprises:
determining whether the third payment verification information is consistent with payment verification information preset for the third target payment account; and
the deducting a payment amount corresponding to the payment request from the login payment account specifically comprises:
deducting the payment amount corresponding to the payment request from the third target payment account.

16. (canceled)

17. (canceled)

18. (canceled)

19. A device, comprising:
a memory and a processor, wherein the memory stores executable instructions that, in response to execution by the processor, cause the processor to:
obtain a payment request that is sent by a target organization and that is generated based on a payment operation performed by a user, wherein the payment request comprises identification information of an authorized payment account, and the authorized payment account is a payment account for which a one-step payment authorization relationship with the target organization is established in advance;
determine account status information of the authorized payment account;
determine, based on the account status information, whether a transaction corresponding to the payment request is at a transaction risk, to obtain a first determining result; and
upon determining that the first determining result indicates that the transaction is not at a transaction risk, perform a first payment procedure; or
upon determining that the first determining result indicates that the transaction is at a transaction risk, perform a second payment procedure comprising a first identity verification process.

20. A non-transitory computer-readable storage medium comprising instructions stored therein that, when executed by a processor of a computing device, cause the processor to:
obtain a payment request that is sent by a target organization and that is generated based on a payment operation performed by a user, wherein the payment request comprises identification information of an authorized payment account, and the authorized payment account is a payment account for which a one-step payment authorization relationship with the target organization is established in advance;
determine account status information of the authorized payment account;
determine, based on the account status information, whether a transaction corresponding to the payment request is at a transaction risk, to obtain a first determining result; and
upon determining that the first determining result indicates that the transaction is not at a transaction risk, perform a first payment procedure; or
upon determining that the first determining result indicates that the transaction is at a transaction risk, perform a second payment procedure comprising a first identity verification process.
